(19) United States
(12) Patent Application Publication
(10) Pub. No.: US 2025/0382998 A1
(43) Pub. Date: Dec. 18, 2025

(54) DISC BRAKE, SECURING ELEMENTS AND RETAINING BRACKET THEREFOR

(71) Applicant: Haldex Aktiebolag, LANDSKRONA (SE)

(72) Inventors: Kjell Önnestam, LÖDDEKÖPINGE (SE); Lee Björnestrand, SÖDRA SANDBY (SE); Hans Welin, SANKT IBB (SE); Martin Wollstad, ASMUNDTORP (SE); Niklas Hult, LANDSKRONA (SE); Slobodan Trivic, HÄLJARP (SE)

(21) Appl. No.: 18/878,345

(22) PCT Filed: Jun. 22, 2023
(86) PCT No.: PCT/EP2023/066980

§ 371 Date: Dec. 23, 2024

(30) Foreign Application Priority Data
Jun. 23, 2022 (DE) 10 2022 115 656.7
Nov. 22, 2022 (DE) 10 2022 130 944.4

(51) Int. Cl. F16D 65/097; F16D 55/225

(52) U.S. Cl. CPC F16D 65/0974; F16D 55/225

(57) ABSTRACT

The present invention relates to securing elements in various embodiments for securing a retaining bracket for tensioning brake linings in a lining shaft of a disc brake.

### BACKGROUND OF THE INVENTION

The present invention relates generally to a disc brake, in particular for a commercial vehicle, with different designs of securing elements acting as a locking device for a retaining bracket which spans a lining shaft of the disc brake and on which lining retaining springs are supported for tensioning the brake linings or brake lining retaining plates.

It is generally known to preload the brake linings or brake lining retaining plates of disc brakes radially in order to prevent rattling noises when driving on an uneven surface, to ensure proper guidance of the brake lining retaining plates on the walls of the lining shaft and, in some cases, to support the resetting of the brake linings when the brakes are released. This pre-tensioning is achieved by means of brake pad retaining springs, which are usually designed as leaf springs and are arranged between the brake pad retaining plates and a retaining bracket forming the abutment for this purpose.

The retaining bracket spans the upward-opening mounting opening of the lining shaft located in the brake caliper of the disc brake, through which the brake linings can be easily removed or inserted for quick mounting or removal. For this purpose, the retaining bracket must have a detachable connection to the brake caliper which, on the one hand, is suitable for the forces occurring in a disc brake and, on the other hand, should be designed without requiring increased force or installation effort in order to enable a quick pad change.

The simplest known implementation based on the state of the art is disclosed in DE 86 15 015 U1, in which the retaining bracket is inserted on one side, which is opposite the actuating mechanism, into a pocket-shaped opening in the brake caliper housing and then fixed over the mounting opening for pretensioning the pad holding-down springs by simply screwing this holding bracket on the opposite side to the brake caliper housing with the aid of a bolt. This design does indeed enable the retaining clip to be held securely, but a threaded hole has to be provided in the brake caliper housing after casting by means of additional, cost-incurring machining steps.

DE 10 2005 044 091 A1 proposes a design in which an upwardly projecting bolt, connected in one piece to the brake caliper, preferably on the inside of the brake, the brake caliper, over which the holding bracket can be placed with a corresponding opening, wherein on the opposite side of the brake, the holding bracket is inserted into a corresponding receiving opening. The bolt can either have a transverse bore, i.e. parallel to the axial direction of the brake disc, or a circumferential groove. The holding bracket is then either fixed in its position by inserting a split pin into the transverse bore of the bolt or by sliding a snap ring over the groove. This design, in turn, has the same disadvantages in that subsequent machining steps are necessary on the brake caliper housing.

The embodiment of a disk brake described in EP 1 069 334 A1 enables the quick assembly and disassembly of the retaining bracket. In this case, the retaining bracket consists of two parts which are connected to each other in the middle of the mounting opening by means of a manually operated tensioning mechanism. As the two parts each engage with one of their ends in corresponding openings or on abutments on the inside or outside of the brake, the retaining bracket is secured in the middle by a corresponding securing means, for example a locking pin, to prevent it from being lost above the mounting opening. However, both halves of the retaining bracket must be provided with a corresponding design to accommodate the securing means, which increases the manufacturing costs. In addition, there is a risk that the securing element will become loose on its own and be lost during driving, so that the two-part retaining bracket loses its abutment function and consequently the brake linings cannot be fixed in the appropriate place, so that there is a general problem of complete failure of such a disc brake.

Another possibility is described in EP 0 703 378 A1, in which circular slots or grooves are provided both on the inside and outside of the brake caliper housing, into which the ends of the retaining bracket engage by simply rotating the retaining bracket around its center. A final fixing is provided by pins that are inserted radially inwards on both sides into corresponding openings that pass vertically through the slots, thus preventing the retaining bracket from being turned out of the slots. Such a solution is also very disadvantageous, as extensive machining steps are required in the brake caliper housing, in particular milling of the semi-circular grooves and provision of corresponding holes to accommodate the locking pins, which is not desirable from a cost perspective.

The disc brake described in EP 1 767 805 A2 proposes a solution in which a spring means is provided which acts essentially in the longitudinal direction of the retaining bracket, i.e. parallel to the axial direction of the brake disc, and braces the retaining bracket between two abutments in the assembled state. The spring means is provided at one end of the retaining bracket so that it engages in a recess on the inside of the brake caliper housing. However, this has the disadvantage that the spring means together with the retaining bracket must only be inserted into the recess under pre-tension, which requires a certain amount of dexterity during assembly and disassembly.

DE 10 2006 039 298 B3 discloses a disc brake in which the retaining bracket has an integrally formed locking tongue which can be deformed in the assembled state and thus prevents longitudinal displacement of the retaining bracket relative to an abutment arranged on the brake caliper housing. However, the locking tongue can only be moved between the mounting or locking position and the removal position during a brake pad change using a tool, which can prove to be extremely cumbersome due to the limited installation space available.

In DE 10 2006 002 306 B4, a spring tongue riveted to the retaining bracket rests against or in an opening on the side of the actuating mechanism. In a further embodiment, a clip bracket is inserted into an opening in the retaining bracket from above, which is located on the side of the actuating mechanism, in order to limit the displacement movement of the retaining bracket, which rests in an opening in the brake caliper on the actuating side and engages around a nose-like projection of the brake caliper on the opposite side.

A securing element in the form of an elongated leaf spring is known from the German utility model DE 20 2008 013 446 U1 of the applicant, which is riveted to the retaining bracket and is shaped at its distal end so that it comes into contact with the nose-like abutment of the brake caliper, which is designed in the form of a hook pointing away from the actuating side, and thus limits the path of the retaining bracket or braces it. In a further embodiment, this utility model proposes a spring element extending transversely to the retaining bracket, which engages from below in an opening in the retaining bracket on the side of the abutment and is attached to the brake caliper with its free ends, so that the opening can be uncovered by simply pressing from above and the retaining bracket can thus be displaced. The disadvantage, however, is that further openings or, if necessary, machined abutment surfaces must be provided in the brake caliper to accommodate the free ends of the spring element, which must be taken into account in the design and thus increase the costs.

Based on the locking devices and securing elements known from the above-described state of the art and the associated disadvantages, the present invention sets itself the task of further developing a disc brake in such a way that, in addition to a relatively inexpensive production of such securing elements, above all a simple and quick assembly and disassembly of the retaining bracket and thus of the brake linings can be realized without restricting the reliability of the disc brake in any way.

### SUMMARY OF THE INVENTION

According to a first functional principle in relation to a securing element, the invention relates to a disc brake, in particular for a commercial vehicle, with a brake caliper which accommodates a brake actuating mechanism and which embraces a brake disc against which brake linings can be pressed on both sides during braking, and with a retaining bracket which can be fastened to the brake caliper and on which lining retaining springs acting on the upper outer edges of the brake linings are supported, on which brake lining retaining springs acting on the upper outer edges of the brake linings are supported, wherein the retaining bracket, which spans a mounting opening of the brake caliper transversely to the direction of rotation of the brake disc, has both its proximal end on the side of the brake actuating mechanism and its opposite distal end positively connected to the brake actuating mechanism, the brake caliper, and with a securing element which is elastically formable and designed in such a way that it interacts with the retaining bracket and/or the brake caliper in order to hold the retaining bracket relative to the brake caliper in its form-fitting fastenings, the retaining bracket having a through-opening in the region of its distal end, with which it rests on a projection of the brake caliper, wherein the securing element is designed as an element separate from the retaining bracket and is configured to at least partially fill the through-opening, and wherein, in accordance with the invention, the securing element is also clamped to the retaining bracket in a captive manner.

The functional principle in this respect is that the securing element, irrespective of its various configurations, restricts the axial displacement of the retaining bracket to such an extent that it cannot be moved out of the mounting opening in the brake caliper on the side of the actuating mechanism into which it is preferably freely inserted with its proximal end, into which it is preferably freely inserted with its proximal end, while it engages with the through opening at its distal end around an abutment on the brake caliper, which projects upwards from the top of the brake caliper in the form of a hook, preferably pointing in the direction of the actuating side. At the same time, the retaining bracket can engage under an undercut of the hook-like abutment with one end of the through opening in order to support itself upwards.

According to the invention, the connection between the securing element and the retaining bracket is preferably such that the retaining bracket is not preloaded in the axial direction, but that there is a certain amount of play between the securing element and the hook-like abutment. For further securing, the securing element can, if necessary, also be designed such that it exerts a spring force on the retaining bracket in the axial direction, which, however, is preferably not selected to be so great that it counteracts simple, preferably manual, assembly and disassembly of the retaining bracket.

In a first embodiment, the securing element is designed as a wire spring. The wire spring has a first linear section that passes through a receiving opening provided on the retaining bracket and extending transversely to it. The receiving opening is preferably located on the underside of the retaining bracket and consists of two eyelets on both sides of the through opening. The dimensions of the eyelets and the wire thickness are selected so that simple, possibly manual assembly is possible, but the wire spring is held securely in the eyelets. Above the linear section, seen in the inserted state of the wire spring, it has a second, curved or wave-shaped section, which is designed in such a way that it engages in the passage opening from above when the linear section is received in the receiving opening. On one side, the wire spring with a loop-shaped section grips the retaining bracket at a distance. The loop-shaped section is dimensioned in such a way that it allows easy manual access for assembly purposes or can be used to hold a corresponding tool.

Furthermore, the curved section has two oppositely inclined legs which are designed in such a way that they each come to rest against the side surfaces of the passage opening, forming a spring effect acting transversely to the longitudinal direction of the retaining bracket, i.e. acting from the inside outwards. Preferably, the curved section rests at least partially against or on the linear section when the latter reaches through the passage opening with its legs.

When the wire spring is fitted, it causes the through-opening on the outside of the hook-like abutment to be reduced so that the retaining bracket can no longer be moved in the axial direction, or only slightly, and thus remains secured below the hook-like projection of the abutment.

For disassembly, the free end of the curved section opposite the loop-shaped section can be lifted so that the legs disengage from the side surfaces of the passage opening and the securing element can be pulled off to the side.

In a second embodiment, the securing element is designed as a spring plate in the form of a clip, which has a corrugated shape with an upper closed end and a lower open end. In the assembled state, the clip reaches through the passage opening so that the closed end is above the retaining bracket. The clip completely fills the passage opening and forms a spring effect acting in the longitudinal direction of the retaining bracket.

At one free end, the clamp or clip has fastening elements that are arranged in opposite directions so that they at least partially engage around the retaining bracket on one, preferably the outer, end face of the through opening. At the other free end, the clamp or clip has a curvature which engages under the retaining bracket on the opposite, i.e. inner, end face of the through opening. In this way, the clamp or clip can be firmly fixed to the retaining bracket as a result of the spring effect, so that its axial movement is restricted. To remove the clamp, which can generally also be named clip, it can be easily compressed so that both the fastening elements and the curvature are disengaged from the retaining bracket.

Preferably, the clip is dimensioned so that it extends over the entire width of the passage opening.

In a third embodiment, the securing element is designed as a spring plate in the form of a U-shaped clip. This clip has a base, two legs and hooks folded over at the free ends. In the assembled state, the base, which is offset downwards in relation to the lateral legs via side flanks, engages from above in the passage opening in such a way that the side flanks come into contact with the outer end face of the passage opening from the inside. The legs in turn come to rest on the top of the retaining bracket, while the hooks at the free ends grip around the edge of the retaining bracket at the side.

In this way, the clip is fixed to the retaining bracket in a captive manner and limits the passage opening on the outside to the hook-like abutment with its base in order to block or restrict the axial movement of the retaining bracket accordingly.

In a fourth embodiment according to the invention, the securing element is designed as a curved, wave-like spring plate in the form of a clip bracket, which can also be named clip bracket, in such a way that it engages in the passage opening while bearing against its inner side surfaces. For this purpose, the clip bracket has two oppositely inclined legs which are designed in such a way that, in a preferred embodiment, they each come into contact with the side surfaces of the passage opening, forming a spring effect acting transversely to the longitudinal direction of the retaining bracket.

The waveform of the clip bracket has at least one upper, semi-circular bend and at least two lower, correspondingly opposite semi-circular bends. Preferably, the upper bend extends above the retaining bracket and the lower bends then lie below the retaining bracket. With its free ends, the clip bracket engages over the lateral edges of the through opening of the retaining bracket, but without exerting a clip effect there. In this way, the clip bracket at least partially fills the through-opening of the retaining bracket on the outside of the hook-like abutment, thereby limiting its axial movement.

In a preferred embodiment of the clip bracket in this embodiment, the upper bend and/or the lower bends are designed such that they can interact with an assembly tool in order to be able to assemble or disassemble the clip bracket.

Furthermore, it is preferred that the oppositely inclined legs of the lower, preferably 180-degree loop-like bends each extend upwards with such an inclination that, when the securing element is fully inserted with its respective sections into the passage opening, these legs each form an undercut relative to the latter, which reliably counteracts easy removal or accidental release of the securing element.

The legs merge into transverse sections which, when the securing element is mounted, come to rest on the lateral, upper edges of the through-opening of the retaining bracket. In turn, sections extend downwards from these transverse sections, at a distance from the outer edges of the retaining bracket, which in a particularly preferred embodiment are also designed like legs and end in a loop-like bend pointing upwards. According to the invention, the free ends of these loops are provided on both sides at such a position that, when the securing element is removed, they come to rest against the retaining bracket below the lateral edges of the through-opening of the retaining bracket. In other words, the distance between the free ends in the transverse direction is smaller than the entire width of the retaining bracket. This prevents the securing element from inadvertently jumping away due to the inherent spring force when an assembly tool engages in one of the loop-like bends. The position of the free ends is also selected in such a way that when they are in contact with the underside of the retaining bracket, the spring force is at least already so low that when an assembly tool engages, the lateral, outer sections can be easily widened in order to be able to remove the securing element without the risk of the securing element jumping away.

Whereas in the embodiments described above, the through-opening in the retaining bracket is designed and dimensioned in such a way that an overhang of the hook-like abutment, which preferably points in the direction of the actuating mechanism and forms an undercut, is undercut by the retaining bracket, so that, when locked by the respective securing elements with at least partial filling of the through opening and thereby limiting the axial displaceability of the retaining bracket, the latter cannot be lifted upwards, whereby the entire mechanism is effected under pretension of the brake retaining springs, the present invention includes a further functional principle in which the securing element interacts directly with the abutment arranged on the brake caliper.

According to a second functional principle in relation to a securing element, the invention also relates to a disc brake, in particular for a commercial vehicle, with a brake caliper which accommodates a brake actuating mechanism and which embraces a brake disc against which brake linings can be pressed on both sides during braking, and with a retaining bracket which can be fastened to the brake caliper and on which lining retaining springs acting on the upper outer edges of the brake linings are supported, on which brake lining retaining springs acting on the upper outer edges of the brake linings are supported, wherein the retaining bracket, which spans a mounting opening of the brake caliper transversely to the direction of rotation of the brake disc, has both its proximal end on the side of the brake actuating mechanism and its opposite distal end positively connected to the brake actuating mechanism, brake actuating mechanism as well as with its opposite, distal end, and with a securing element which is elastically formable and designed such that it cooperates with the brake caliper in order to hold the retaining bracket relative to the brake caliper in its form-fitting fastenings, wherein the securing element is formed as an element separate from the retaining bracket and is designed to at least partially fill the through-opening, wherein the brake caliper has a projection on the side opposite the brake actuating mechanism, and wherein the securing element is clamped to the projection of the brake caliper in a captive manner.

In this embodiment, the securing element can be designed as a spring plate in the form of a clip with a central section which engages from above in the through opening and thereby engages around the projection of the brake caliper, and two lateral sections which can engage laterally around the projection or an edge of the retaining bracket. As in the previously described embodiments of the first functional principle, the passage opening in the retaining bracket is thereby narrowed in such a way that it can no longer move relative to the projection or can only move with a small amount of play, thereby blocking its axial displacement.

The projection serving as an abutment for the retaining bracket is also shaped in the form of a hook, which points in the direction of the brake actuation mechanism and has a continuous opening opposite, into which a distal end of the retaining bracket extends.

In addition, the central section of the clip may have fastening elements that engage under a cross brace of the brake caliper projection that is exposed as a result of the through opening.

In particular, the invention also relates to securing elements as such in the various embodiments described above, which have in common that they are formed in one piece and can be produced in a simple manner by bending and/or punching, preferably from a spring sheet.

Furthermore, the invention relates to a third functional principle in relation to the securing element, which is itself a component of the retaining bracket. In particular, the invention also relates to such a retaining bracket as such.

In accordance with this functional principle in relation to a securing element, the invention also relates to a disc brake, in particular for a commercial vehicle, with a brake caliper which accommodates a brake actuating mechanism and embraces a brake disc against which brake linings can be pressed on both sides during braking, and with a retaining bracket which can be fastened to the brake caliper and on which lining retaining springs acting on the upper outer edges of the brake linings are supported, on which brake lining retaining springs acting on the upper outer edges of the brake linings are supported, wherein the retaining bracket, which spans a mounting opening of the brake caliper transversely to the direction of rotation of the brake disc, has both its proximal end on the side of the brake actuating mechanism and its opposite distal end positively connected to the brake actuating mechanism, the retaining bracket, which spans a mounting opening of the brake caliper transversely to the direction of rotation of the brake disc, is positively secured to the brake caliper both by its proximal end on the side of the brake actuating mechanism and by its opposite, distal end, and having a securing element which is elastically formable and is designed such that it interacts with the brake caliper in order to hold the retaining bracket in its positive-locking fastenings with respect to the brake caliper, the brake caliper having a projection with an opening on the side opposite the brake actuating mechanism, and the retaining bracket having the securing element integrally in the region of its distal end with a free end which is designed to engage behind the opening in the projection.

Preferably, the securing element is designed as a type of spring tongue, which can be realized in terms of design by punching and bending the retaining bracket, which is preferably made of sheet metal.

As a result of the through-opening, the hook pointing towards the actuating side has an exposed cross strut with which a hook-like extension at the distal end of the spring tongue engages.

For further stabilization, the front end of the retaining bracket can grip around the side of the brake caliper projection.

### BRIEF DESCRIPTION OF THE DRAWINGS

Further features and advantages of the invention are apparent from the following description of the various embodiments with reference to the corresponding drawings. Hereby show

FIG. 1 is a schematic partial sectional view through a brake caliper to show the mounted state of a securing element in a first embodiment according to the invention;

FIG. 2 is the securing element in the first embodiment;

FIG. 3 is a retaining bracket formed for this securing element;

FIG. 4 is a perspective view of the mounted state of this securing element;

FIG. 5 is a partial sectional view through the brake caliper and the securing element to show the assembled state;

FIGS. 6a-c are views of a securing element in a second embodiment according to the invention in various views;

FIG. 7 is a partial sectional view through the brake caliper to show the assembled state of this securing element;

FIG. 8 is a partial perspective view showing the mounted securing element;

FIG. 9 is a further partial perspective view showing the mounted state of the securing element;

FIGS. 10a-d are views of a securing element in a third embodiment according to the invention in various views;

FIG. 11 is a partial perspective view showing the assembled state of this securing element;

FIG. 12 is a further partial perspective view showing the assembled state of the securing element;

FIG. 13 is a partial sectional view through the brake caliper to show the assembled state of the securing element;

FIG. 14 is a securing element in a fourth embodiment according to the invention;

FIGS. 15a-c are schematic perspective views of individual steps in the assembly of this securing element and a retaining bracket;

FIG. 16 is a partial sectional view through the brake caliper to show the assembled state of the securing element;

FIG. 17 is a perspective view from below of a securing element in a fifth embodiment according to the invention;

FIG. 18 is a partial sectional view through the brake caliper to show the assembled state of this securing element;

FIGS. 19 a-d are schematic perspective views of individual steps in the assembly of this securing element and a retaining bracket;

FIG. 20 is a perspective view of a retaining bracket with an integral securing element according to the invention;

FIGS. 21 a-c are schematic perspective views of individual steps in the assembly of this retaining bracket;

FIG. 22 is a perspective view of a securing element in a seventh embodiment;

FIG. 23 is a sectional view of this securing element in the assembled state; and

FIGS. 24a-c schematically show individual steps in the assembly and disassembly of this securing element.

### DETAILED DESCRIPTION OF THE PREFERRED EMBODIMENTS

All embodiments of a securing element 11, 20, 30, 37, 47, 58 and 65 to be described below serve to securely hold and fix a retaining bracket 1, 21, 31, 39, 57 and 62 on a brake caliper 2, whereby, according to the invention, simple assembly and disassembly of both the securing element 11, 20, 30, 37, 47, 58 and 65 and the retaining bracket 1, 21, 31, 39, 57 and 62 is ensured at the same time. The retaining bracket 1, 21, 31, 39, 57 and 62 serves as an abutment for brake pad retaining springs 3, which are arranged on the upper side of brake pad retaining plates 4 in order to brace these in a brake pad shaft 5 of the brake caliper, as can best be seen in FIG. 15a-c or 19a-d. As a result, the brake lining retaining plates 4 with the brake linings 6 arranged thereon are guided in the lining shaft 5 without vibrating.

Furthermore, all embodiments have in common that the retaining brackets 1, 21, 31, 39, 57 and 62 are received with their proximal ends, i.e. on the side of a brake actuation mechanism not shown, in an opening 7 in the brake caliper 2 with a certain amount of play or are inserted into it. In the mounted state, the retaining brackets 1, 21, 31, 39, 57 and 62 span the lining shaft 5 and thus both brake lining retaining plates 4 in an axial direction which corresponds to the actuation direction when the brake linings 6 are adjusted.

For the purpose of securing, the retaining brackets 1, 21, 31, 39, 57 and 62 interact positively at the opposite side with their respective distal ends with an upwardly projecting projection 8, 48 and 59, which serves as an abutment and is integrally formed on the brake caliper 2. The abutment 8, 48 and 59 has the overall shape of a hook, which extends in the axial direction towards the actuating side and has a hook-like projection or overhang 9 10, which, when viewed from above, forms an undercut with a groove 10, into which the retaining bracket 1, 21, 31, 39, 57 and 62 lies with the actuation-side end face of its respective through-openings 12, 22, 32, 38 and 56, as can be seen in particular in FIG. 5. In the mounted, i.e. secured state, the retaining bracket 1, 21, 31, 39, 57 and 62 can therefore not migrate upwards, but is supported upwards on the distal side on the hook-like extension 9 on the one hand and on the proximal side in the opening 7 on the other hand and thereby braces the brake lining retaining plates 4 by means of the brake lining retaining springs 3, whereby a minimal movement of the retaining bracket 1, 21, 31, 39, 57 and 62 in its axial direction may be possible.

The securing elements 11, 20, 30, 37, 47, 58 and 65 ensure that this axial movement is restricted completely or at least to such an extent that the retaining bracket 1, 21, 31, 39, 57 and 62 cannot move out of engagement with the groove 10.

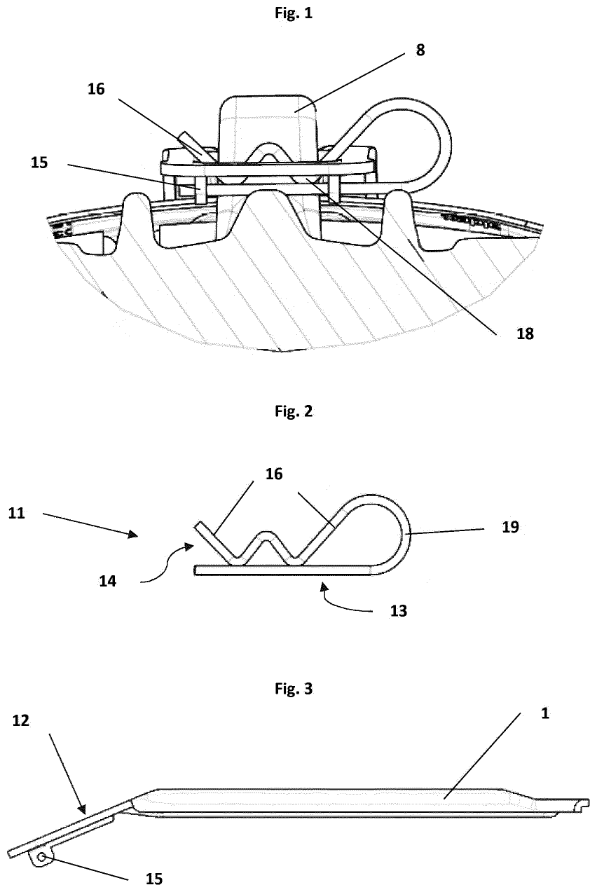

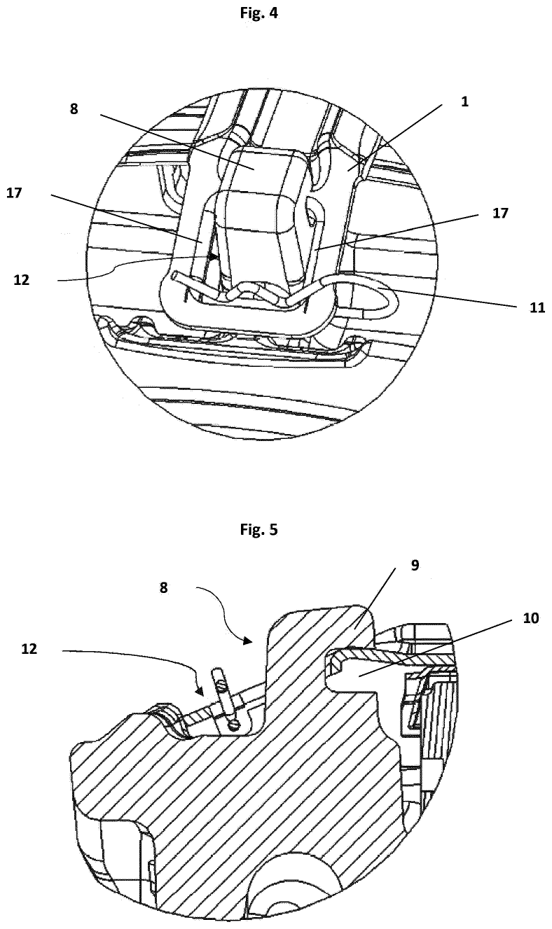

FIGS. 1 to 5 show a first securing element 11 according to the invention.

The retaining bracket 1 has a through opening 12 at its distal end, through which the hook-like projection 8 passes, as can be seen in FIGS. 4 and 5.

On the outside of the projection 8, the locking element 11 works together with the retaining bracket 1 to lock it against excessive axial displacement.

The securing element 11 in this embodiment is bent in one piece from a spring wire and has a lower linear section 13 and an upper, wave-shaped section 14.

As can be seen in FIG. 1, the linear section 13 engages through a receiving opening in the retaining bracket 1, which is formed by two eyelets 15 arranged on opposite sides of the through-opening 12. In the assembled state, the wave-shaped section 14 engages from above in the through-opening 12, whereby two limbs 16 of the wave-shaped section 14, which open away from each other, come to rest on the respective inner side edges or surfaces 17, which have a corresponding inclination. The corrugated section 14 or its legs 16 can be dimensioned in relation to the passage opening 12 in such a way that these legs 16 exert a spring force acting from the inside outwards, which is sufficient to hold the securing element 11 securely on the retaining bracket 1. Preferably, the lower bends 18 of the wave-shaped section 14 are supported on the linear section 13.

As can be seen in FIG. 5 in particular, this reduces the opening width of the passage opening 12 to such an extent that the retaining bracket 1 can no longer be moved axially to such an extent that there would be a risk of it becoming disengaged from the groove 10 on the opposite side.

The securing element 11 also has a loop-like section 19 that allows manual handling or access with a tool for assembly purposes.

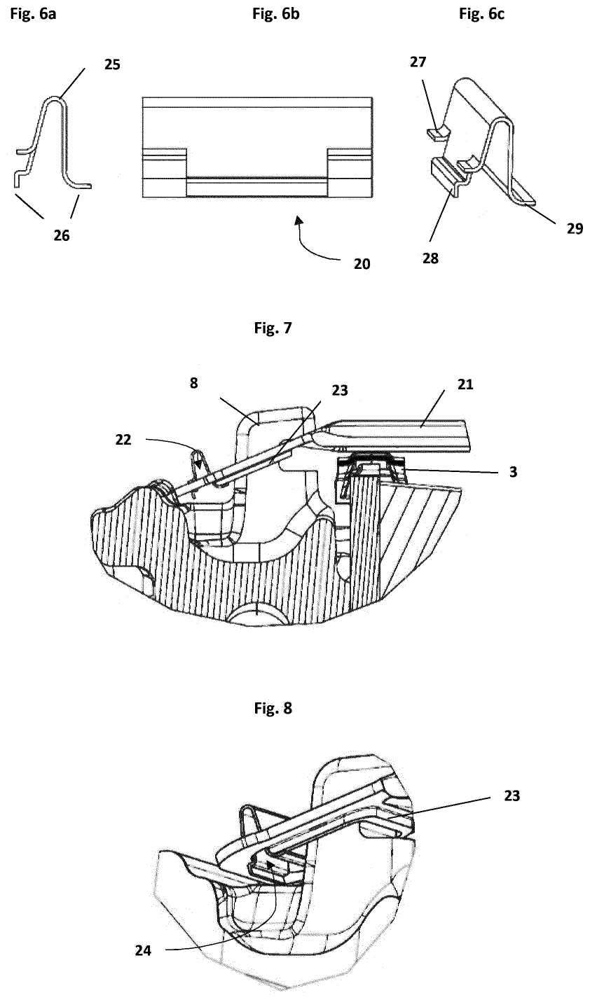

FIGS. 6a to 9 show a second securing element 20 according to the invention.

The corresponding retaining bracket 21 has a through-opening 22, through which the projection 8 passes, and on the underside a U-shaped-bead 23 surrounding the through-opening 22—, which does not extend completely to the outer end face of the through-opening 22, but defines a free area 24 with an extended width.

The securing element 20 is designed in the form of a wave-shaped clip made of spring plate with an upper closed end 25 or a bend and two lower free ends 26. The clip 20 widens downwards. Clip or fastening elements 27 and 28 in the form of opposing hooks are arranged at one free end 26, while a bend or curvature 29 is provided outwards at the other free, opposite end.

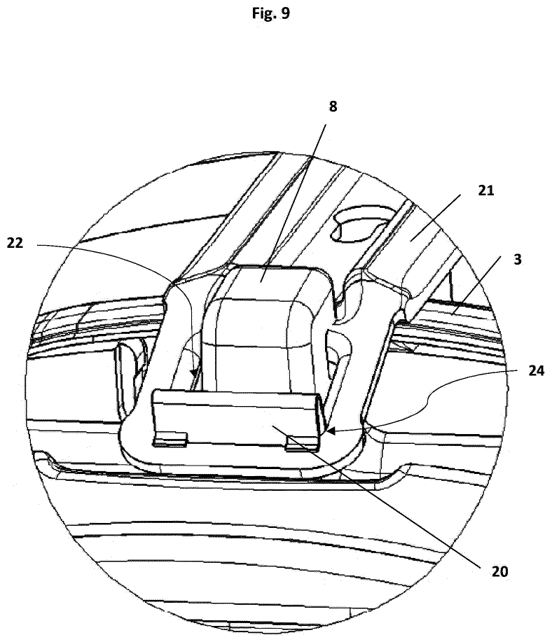

As can be seen in FIGS. 7 to 9, the hook-like fastening elements 27 and 28 engage around the outer end face of the through opening 22, while the bulge 29 comes to rest against the underside of the bead 23. The clip 20 exerts a spring effect in the axial direction of the retaining bracket 21, which holds this securing element 20 securely in the through opening 22.

As can be seen in FIG. 9, the securing element 20 extends over the entire width of the free area 24 of the through-opening 22. Furthermore, as can be seen in FIG. 7, the curvature 29 does not come into direct contact with the projection 8, so that a certain, albeit small, clearance is ensured with respect to axial displacement of the retaining bracket 21.

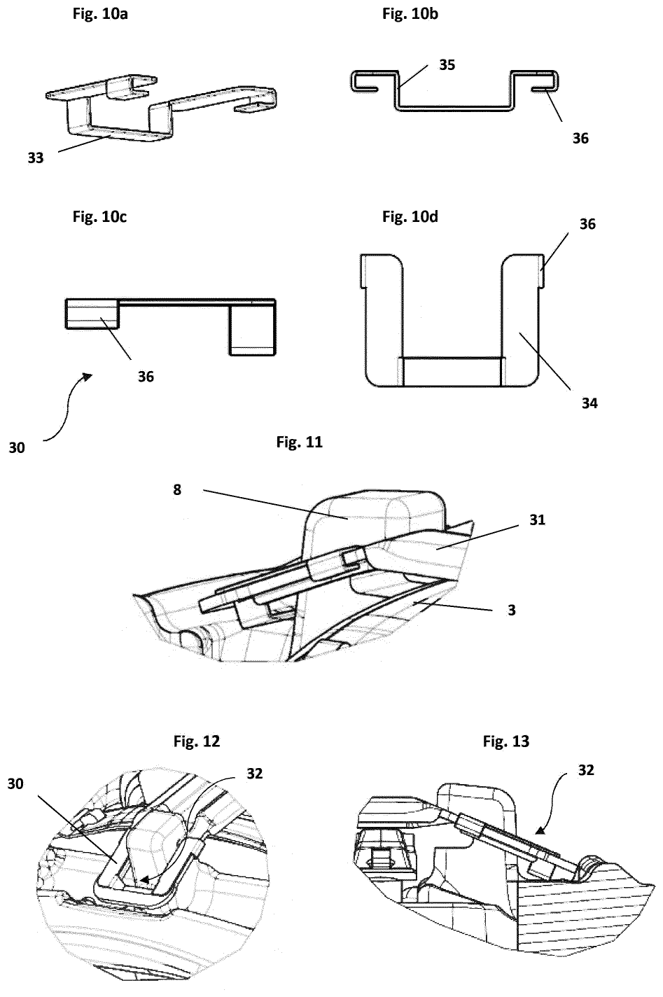

FIGS. 10a to 13 show a third securing element 30 according to the invention.

As in the preceding embodiments, this securing element 30 interacts with a retaining bracket 31 in such a way that it opens a through opening 32 in this retaining bracket 31 is reduced accordingly to counteract its axial displacement.

The securing element 30 is preferably bent and punched from a spring sheet and is essentially U-shaped, with a base 33 and two lateral legs 34, whereby the base 33 is offset downwards in relation to the legs 34 via side flanks 35. Folded hooks 36 are provided at the ends of each leg 34.

As can be seen in FIGS. 11 to 13, the securing element 30 is mounted in the passage opening 32 in such a way that the base 33 lies below the passage opening 32, with the side flanks 35 coming to rest on its outer end face, while at the same time the flat legs 34 on the upper side of the retaining bracket 31 rest on the edge of the passage opening 32. The securing element 30 is ultimately secured by the folded hooks 36 engaging around the side edges of the retaining bracket 31.

As can be seen in FIG. 13, the base 33 does not necessarily come into contact with the outer surface of the projection 8, but allows a small amount of play in relation to the axial movement of the retaining bracket 31.

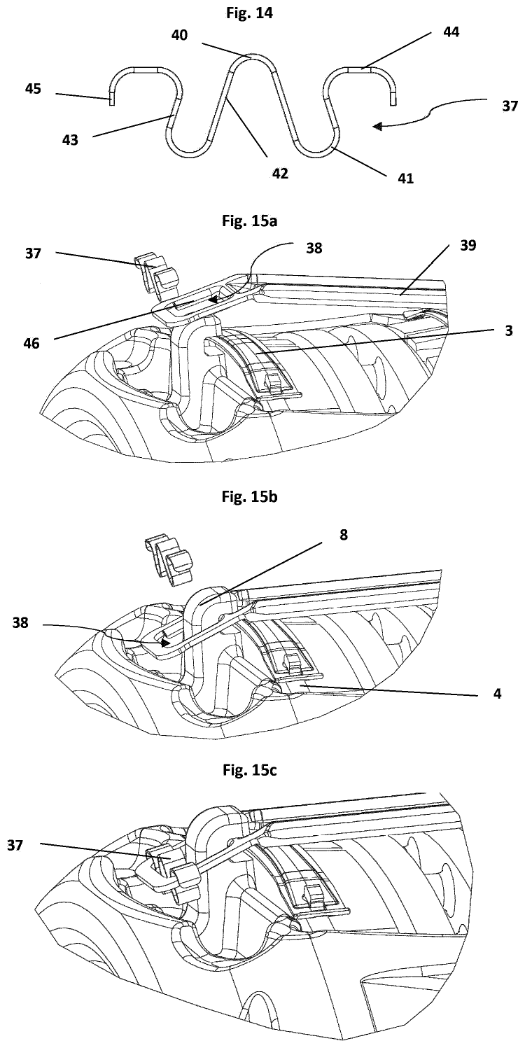

FIGS. 14 to 16 show a fourth securing element 37 according to the invention.

Here too, the securing element 37 is used to reduce the size of a passage opening 38 in a retaining bracket 39 accordingly.

The securing element 37 in this embodiment is designed in the form of an undulating clip bracket. Preferably, this clip bracket 37 has an upper bend 40 and two lower bends 41, between which two internal legs 42 extend. The bends 40 and 41 are formed in the shape of loops of essentially 180degrees. From the lower bends 41, in turn, outer legs 43 extend upwards again, which merge into transverse sections 44 with downwardly curved sections 45.

FIGS. 15a-c show an example of the assembly process. The retaining bracket 39, after it has been inserted with its proximal end into the actuation-side opening 7, is placed with its through-opening 38 over the integral projection 8 of the brake caliper (FIG. 15a), then displaced outwards in the axial direction so that the inner end face of the through-opening 38 engages in the groove 10 of the projection 8 (FIG. 15b) and finally the retaining bracket 39 is locked against axial displacement by inserting or plugging the securing element 37 into the remaining exposed area of the through-opening 38 from above (FIG. 15c).

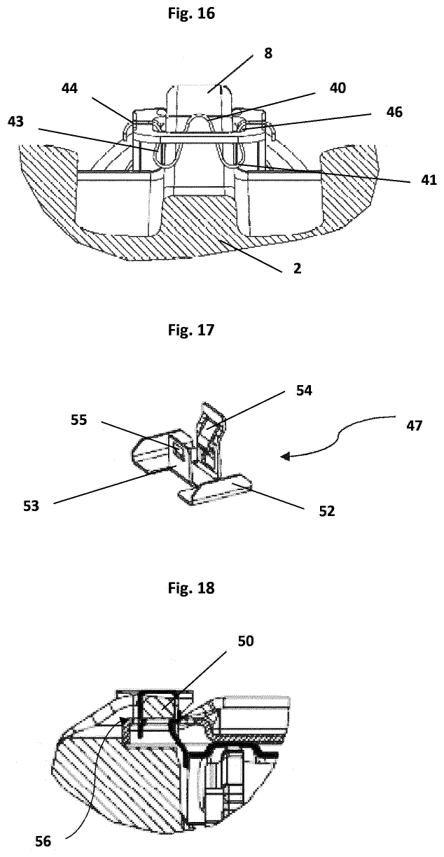

As can be seen in FIG. 16, the outer legs 43 come into contact with the corresponding inner edges 46 of the through-opening 38, whereby the clip bracket is preferably designed and dimensioned in such a way that a spring effect acting from the inside to the outside is generated, which clamps the clip bracket to the retaining bracket 39 so that it cannot be lost. The upper bend 40 is arranged above the retaining bracket 39, while the lower bends 41 are located below the retaining bracket 39. The transverse sections 44 do not necessarily have to rest completely on the surface of the retaining bracket 39, nor do their sections 45 have a clip effect. Rather, they can serve to repel dirt.

The upper bend 40 is preferably located far enough above the retaining bracket 39 to allow easy access to the upper section using an assembly tool.

In addition to the spring effect acting outwards from the legs 43, supporting it in the process, or even without the presence of such a spring effect, the legs 43 are designed in such a way that they each form an undercut on both sides in relation to the through opening 38, which prevents the securing element 37 from automatically jumping out of the through opening 38.

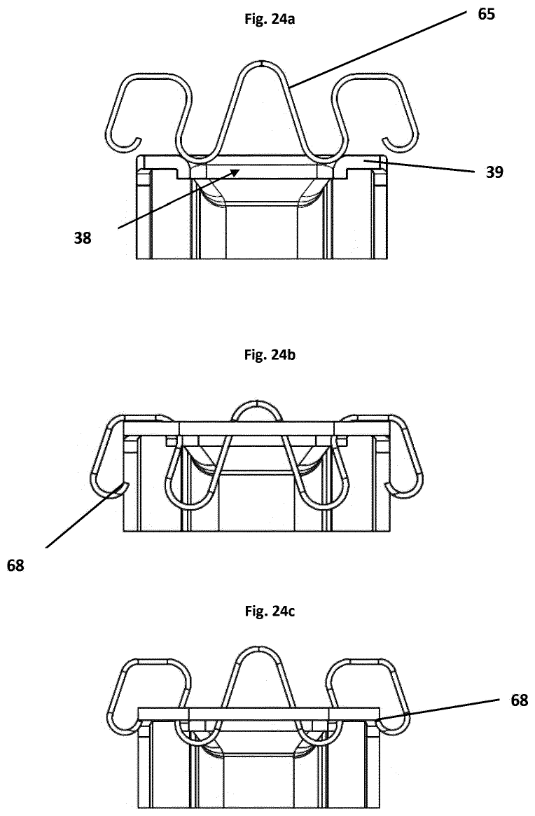

FIGS. 22 to 24c show a further development of the previously described securing element 37. This securing element 65 is almost identical in structure and function, with identical reference signs characterizing identical sections.

The transverse sections 44 merge here into leg-like sections 66, which continue into loops or bends 67 of almost 180 degrees, each ending in free ends 68, which are directed upwards towards the retaining bracket 39.

As FIGS. 24a-c show, the free ends 68 are in a position such that they come into contact with the underside of the lateral edges of the through-opening 38 of the retaining bracket 39 when the securing element 65 is removed. In this way, the securing element 65 is prevented from jumping away as a result of the existing spring effect. This simplifies the disassembly process and makes it safer. When the free ends 68 are in contact, the spring effect prevailing in the securing element 65 is already so weakened or even no longer present that the lateral sections 66 can be easily widened by means of interaction with an appropriate assembly tool and thus the free ends 68 can be disengaged from the retaining bracket 39. The securing element 65 can then be removed manually in a simple manner.

FIGS. 17 to 19d show a fifth securing element 47 according to the invention which, in contrast to the embodiments described above, does not interact directly with a retaining bracket, but with an integral projection 48 of the brake caliper 2.

The corresponding projection 48, which serves as an abutment, is also shaped in the form of a hook pointing towards the actuating side, but also has an opening 49 such that the hook ends in a cross strut 50.

The securing element 47 is manufactured as a stamped and bent sheet metal part and has a central section 51 and, adjacent to it, two lateral sections 52.

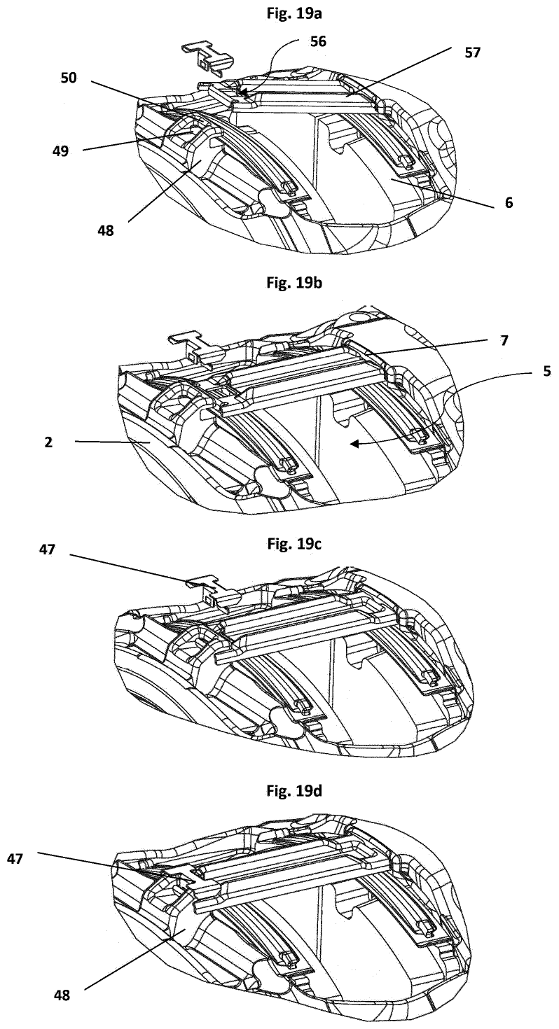

The central section 51, seen in the assembled state, has two downwardly extending legs 53, which have hook-like fastening elements 54 and 55, which engage under the cross strut 50, as can be seen in FIG. 18. The lateral sections 52 then engage around the sides of the projection 48 accordingly, as shown in FIG. 19d.

By clip the securing element 47 in this way with the cross strut 50 of the projection 48 in a captive manner, both legs 53 extend from above into a through opening 56 of a corresponding retaining bracket 57, thereby limiting its axial mobility.

The assembly process is illustrated by way of example in the sequence of FIGS. 19a to d.

The proximal end of the retaining bracket 57 is inserted into the actuation-side opening 7 in the brake caliper 2 (FIG. 19a), pivoted downwards (FIG. 19b) and then displaced in the axial direction towards the projection 48 (FIG. 19c) until the through-opening 56 is arranged below the cross strut 50 in such a way that both legs 53 engage through the through-opening 56 when the securing element 47 jams with the cross strut (FIG. 19d).

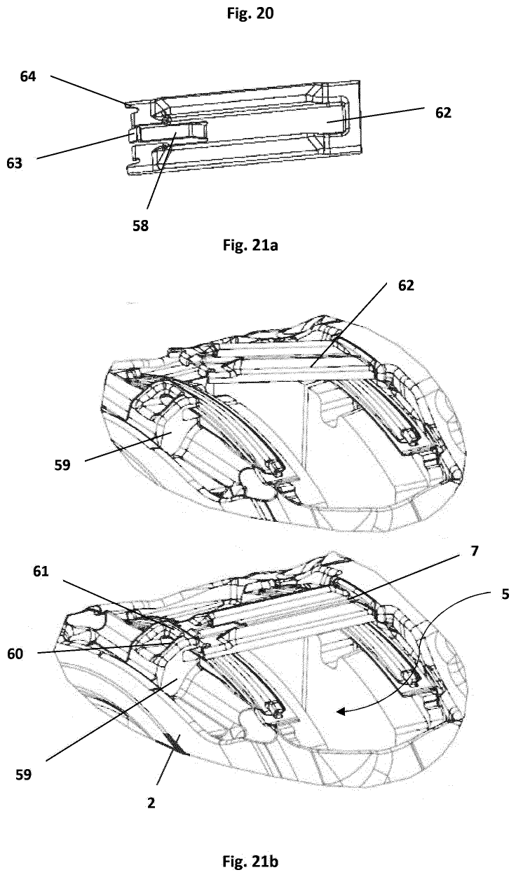

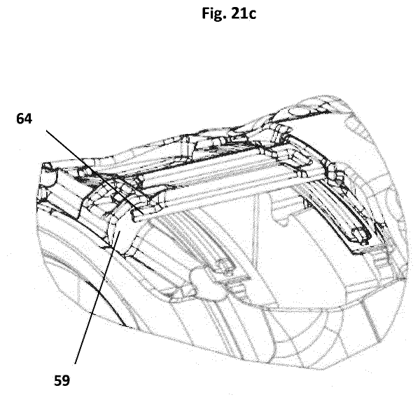

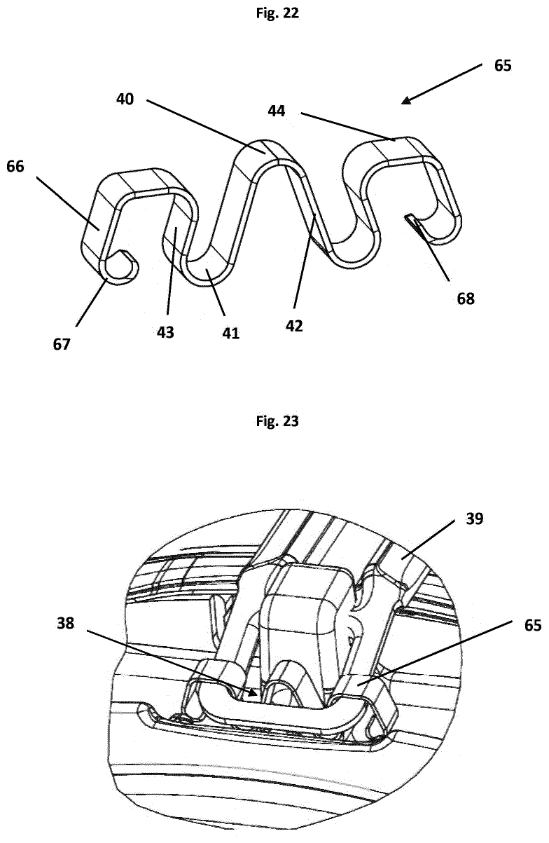

FIGS. 20 to 21c show a sixth securing element 58 according to the invention, which is also designed to cooperate directly with an integral projection 59 of the brake caliper 2.

The projection 59 is also provided with an opening 60 in relation to this securing element 58, forming a cross strut 61.

In this embodiment, the securing element 58 is formed integrally with the retaining bracket 62, which is preferably stamped and deep-drawn from a spring plate, as a type of spring tongue which has a hook 63 at its distal end.

As can be seen in the sequence of FIGS. 21a to c, the retaining bracket 62, after it is received in the opening 7 on the actuating side (FIG. 21a), is pivoted downwards and displaced in the direction of the projection 59 (FIG. 21b) until the resilient hook 63 engages behind the cross strut 61 and thus axially fixes the retaining bracket 62. It is released in a simple manner by pressing the hook 63 downwards using a tool and then moving the retaining bracket 62 inwards.

The retaining bracket 62 also has a nose-like projection 64 on each side, which comes to rest on the side of the projection 59 for stabilization purposes.

1.-34. (canceled)

35. A disc brake for a commercial vehicle, comprising:
a brake caliper which accommodates a brake actuating mechanism and embraces a brake disc against which brake linings can be pressed on both sides during braking; and
a retaining bracket on which brake lining retaining springs acting on the upper outer edges of the brake linings are supported;
wherein the retaining bracket spanning a mounting opening of the brake caliper transversely to the direction of rotation of the brake disc is positively secured to the brake caliper both with a proximal end of the retaining bracket on the side of the brake actuating mechanism and an opposite, distal end of the retaining bracket, and with a securing element which is elastically deformable and configured such that the securing bracket cooperates with the retaining bracket and/or the brake caliper to hold the retaining bracket relative to the brake caliper in form-locking fastenings, the retaining bracket in the region of its distal end has a through-opening with which the retaining bracket engages on a projection of the brake caliper;
wherein the securing element comprises an element separate from the retaining bracket and that is configured to at least partially fill the through-opening; and
wherein the securing element is clamped to the retaining bracket in a captive and/or secure manner.

36. The disc brake according to claim 35, wherein the curved section has two oppositely inclined limbs which are configured such that the inclined limbs each come to bear against the side surfaces of the passage opening forming a spring effect acting transversely to the longitudinal direction of the retaining bracket.

37. The disc brake according to claim 35, wherein the securing element comprises as a spring plate in the form of a clip, which has a corrugated shape with an upper closed end and with a lower open end and which engages through the passage opening with the closed end above the retaining bracket forming a spring action acting in the longitudinal direction of the retaining bracket.

38. The disc brake according to claim 37, wherein the clip or clamp has fastening elements at one free end which at least partially engage around the retaining bracket at one end face of the passage opening, and a curvature at the other free end, which engages under the retaining bracket.

39. The disc brake according to claim 37, wherein the clip extends over an entire width of the passage opening.

40. The disc brake according to claim 35, wherein the securing element comprises a spring plate in the form of a U-shaped clip such that a base engages in the through opening from above while bearing against the side surfaces and/or the outer end face thereof, legs come to bear on the upper side of the retaining bracket and the free ends engage laterally around the retaining bracket.

41. The disc brake according to claim 35, wherein the securing element comprises a spring plate in the form of a clip bracket such that the clip bracket engages in the through opening while bearing against side faces of the opening.

42. The disc brake according to claim 41, wherein the clip bracket has two oppositely inclined legs which are configured such that each leg comes to bear against the side surfaces of the through-opening forming a spring effect acting transversely to the longitudinal direction of the retaining bracket.

43. The disc brake according to claim 42, wherein the clip bracket has a wave form with at least one upper bend and at least two lower bends, wherein the upper bend and/or the lower bends are configured to receive an assembly tool.

44. The disc brake according to claim 43, wherein the legs extend from the lower bends at such an inclination that the legs form an undercut in relation to the passage opening in an inserted state.

45. The disc brake according to claim 41, wherein the securing element externally comprises respective sections which continue in bends having free ends at such a position that the bends come to rest against the underside of the retaining bracket when the securing element is pulled out of the through opening.

46. A disc brake for a commercial vehicle, comprising:
a brake caliper which accommodates a brake actuating mechanism and embraces a brake disc against which brake linings can be pressed on both sides during braking; and
a retaining bracket which is configured to be fastened to the brake caliper on which brake lining retaining springs acting on the upper outer edges of the brake linings are supported;
wherein the retaining bracket, which spans a mounting opening of the brake caliper transversely to the direction of rotation of the brake disc, both with a proximal end thereof on the side of the brake actuating mechanism and with an opposite distal end thereof is positively connected to the brake actuating mechanism, the brake caliper, and with a securing element which is elastically deformable and is configured such that the securing element cooperates with the brake caliper in order to hold the retaining bracket relative to the brake caliper in positive-locking fastenings, the brake caliper having a projection on the side opposite the brake actuating mechanism, the securing element comprising an element separate from the retaining bracket and being configured to at least partially fill a through opening in the retaining bracket; and
wherein the securing element is clamped to the projection of the brake caliper in a captive manner.

47. A disc brake, comprising:
a securing element which is elastically deformable and is configured to hold a retaining bracket for brake retaining springs relative to a brake caliper of a disc brake in positive-locking fastenings by at least partially filling a through-opening in the retaining bracket, wherein the securing element comprises a spring plate in the form of a clip which has a wave shape with an upper closed end and with a lower open end and which is configured to engage through the through-opening with the closed end above the retaining bracket, forming a spring effect acting in the longitudinal direction of the retaining bracket.

48. The disc brake according to claim 47, wherein the clip has fastening elements at one free end, which is configured to engage at least partially around the retaining bracket at one end face of the passage opening, and that has a curvature at the other free end which is configured to engage under the retaining bracket.

49. A disc brake, comprising:
a securing element which is elastically deformable and is configured to hold a retaining bracket for brake hold-down springs relative to a brake caliper of a disc brake in positive-locking fastenings by at least partially filling a through-opening in the retaining bracket, wherein the securing element comprises a spring plate in the form of a clip bracket such that the securing element can engage in the through opening while bearing against the side faces of the through opening.

50. The disc brake according to claim 49, wherein the clip bracket has two oppositely inclined legs which are configured to come to rest against the side faces of the through-opening, in each case forming a spring effect acting transversely to the longitudinal direction of the retaining bracket.

51. The disc brake according to claim 49, wherein the clip bracket has a wave form with at least one upper bend and at least two lower bends, and wherein the upper bend and/or the lower bends are configured to receive an assembly tool.

52. The disc brake according to claim 51, wherein the legs) extend from the lower bends at such an inclination that the legs form an undercut with respect to the through opening when inserted.

53. The disc brake according to claim 49, wherein the securing element externally comprises respective sections which continue in bends having free ends at such a position that the free ends come to rest against the underside of the retaining bracket when the securing element is pulled out of the through opening.
